(19) United States
(12) Patent Application Publication
(10) Pub. No.: US 2025/0227485 A1
(43) Pub. Date: Jul. 10, 2025

(54) CONCURRENT WI-FI AWARE DISCOVERY AND WLAN OPERATION

(71) Applicant: Samsung Electronics Co., Ltd., Suwon-si (KR)

(72) Inventors: Bilal Sadiq, Plano, TX (US); Boon Loong Ng, Plano, TX (US)

(21) Appl. No.: 19/006,018

(22) Filed: Dec. 30, 2024

Related U.S. Application Data
(60) Provisional application No. 63/618,067, filed on Jan. 5, 2024.

(51) Int. Cl. H04W 16/14; H04W 8/00; H04W 84/12

(52) U.S. Cl. CPC H04W 16/14; H04W 8/005; H04W 84/12

(57) ABSTRACT

Methods and systems for anchor placement in concurrent Wi-Fi Aware discovery and WLAN operation. A computer-implemented method includes performing a concurrent operation at a first wireless device in a plurality of bands. Operation in a first band of the plurality of bands is active intermittently using a first antenna and based on configurations of a radio frequency (RF) module of the first wireless device and operation in a second band of the plurality of bands is active continuously using the first antenna and a second antenna. The configurations of the RF module include a first configuration to initiate an intermittently active discovery operation in the first band and a second configuration to end of the intermittently active discovery operation in the first band.

### CROSS-REFERENCE TO RELATED APPLICATIONS AND CLAIM OF PRIORITY

The present application claims priority to U.S. Provisional Patent Application No. 63/618,067, filed on Jan. 5, 2024. The contents of the above-identified patent documents are incorporated herein by reference.

### TECHNICAL FIELD

The present disclosure relates generally to wireless communication systems. More specifically, the present disclosure relates to a system and method for concurrent Wi-Fi Aware discovery and WLAN operation using wireless technology.

### BACKGROUND

Wireless devices, such as a non-access point (AP) station (STA), may need to maintain multiple operations concurrently. For example, a smart TV or mobile phone may maintain a WLAN infrastructure operation with an AP in one band, e.g., in a 5 GHz band, while concurrently maintaining a device-to-device operation, such as Neighborhood Aware Networking (NAN), in another band, e.g., a 2.4 GHz band. However, to simultaneously receive transmissions in two bands, devices need to reconfigure their radio frequency (RF) module to have reduced capabilities, e.g., fewer antennas, per band than that of a single-band operation resulting in data rate loss on the channel connected to the AP.

Accordingly, there is a need for systems and methods for improved concurrent Wi-Fi Aware discovery and WLAN operation that overcome these challenges.

### SUMMARY

The present disclosure relates generally to wireless communication systems and, more specifically, the present disclosure relates to a system and method for concurrent Wi-Fi Aware discovery and WLAN operation using wireless technology.

In one embodiment, a computer-implemented method is provided. The computer-implemented method includes performing a concurrent operation at a first wireless device in a plurality of bands. Operation in a first band of the plurality of bands is active intermittently using a first antenna and based on configurations of a RF module of the first wireless device and operation in a second band of the plurality of bands is active continuously using the first antenna and a second antenna. The configurations of the RF module include a first configuration to initiate an intermittently active discovery operation in the first band and a second configuration to end of the intermittently active discovery operation in the first band.

In another embodiment, an electronic device is provided. The electronic device includes a first antenna, a second antenna, a RF module, and a processor operably coupled to the first antenna and the second antenna. The processor is configured to cause the electronic device to perform a concurrent operation in a plurality of bands. Operation in a first band of the plurality of bands is active intermittently using the first antenna and based on configurations of the RF module and operation in a second band of the plurality of bands is active continuously using the first antenna and the second antenna. The configurations of the RF module include a first configuration to initiate an intermittently active discovery operation in the first band, and a second configuration to end of the intermittently active discovery operation in the first band.

In yet another embodiment, a non-transitory computer-readable medium is provided. The non-transitory computer-readable medium includes program code, that when executed by at least one processor of an electronic device, causes the electronic device to perform a concurrent operation in a plurality of bands. Operation in a first band of the plurality of bands is active intermittently using a first antenna and based on configurations of a radio frequency (RF) module of the first wireless device and operation in a second band of the plurality of bands is active continuously using the first antenna and a second antenna. The configurations of the RF module include a first configuration to initiate an intermittently active discovery operation in the first band; and a second configuration to end of the intermittently active discovery operation in the first band.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3 illustrates an example system performing concurrent Wi-Fi Aware discovery and WLAN operation in an environment according to various embodiments of the present disclosure;

FIG. 4 illustrates an example method of concurrent Wi-Fi Aware discovery and WLAN operation according to embodiments of the present disclosure;

FIG. 5A illustrates an example band operation timeline of a system undergoing a method of concurrent Wi-Fi Aware discovery and WLAN operation according to embodiments of the present disclosure;

FIG. 5B illustrates an example channel configuration timeline of a system undergoing a method of concurrent Wi-Fi Aware discovery and WLAN operation according to embodiments of the present disclosure;

FIG. 6A illustrates an example indication timeline of a system undergoing a method of concurrent Wi-Fi Aware discovery and WLAN operation according to embodiments of the present disclosure; and

FIG. 6B illustrates an example indication timeline of a network system undergoing a method of concurrent Wi-Fi Aware discovery and WLAN operation according to embodiments of the present disclosure.

### DETAILED DESCRIPTION

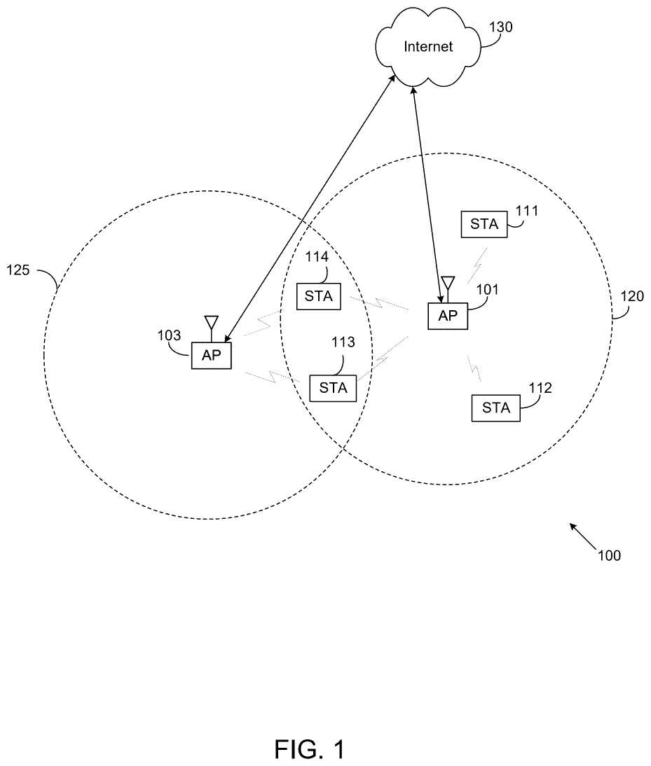

FIG. 1 through FIG. 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, a user wireless device, such as a non-access point (AP) station (STA), may need to maintain multiple operations concurrently. For example, a smart TV, e.g., a non-AP STA, may maintain a WLAN infrastructure operation with an AP in one band, e.g., in a 5 GHz band, while concurrently maintaining a device-to-device operation, such as Neighborhood Aware Networking (NAN), in another band, e.g., a 2.4 GHz band. Other examples of such a non-AP STA include a mobile phone connected to an AP on a channel in 5 GHz band and concurrently participating in NAN synchronization and discovery on channel 6 in 2.4 GHz band. NAN operation on channel 6 requires a low duty cycle to reduce power consumption and channel occupancy. Further, NAN operation requires the radio frequency communication to be active on channel 6 only intermittently, e.g., during a subset of discovery windows, and possibly for discovery beacon transmissions, e.g., when the wireless device acts as Master of a NAN cluster.

To do so, the wireless device may indicate to the AP that the wireless device is entering a sleep state for the duration of the channel 6 active window, and then reconfigure all receiver chains over to channel 6 to perform the NAN-related operation. Thus, the infrastructure WLAN connection will enter a doze state where data communication is not possible. This suspension of data communication is undesirable due to the impact on audio/video quality, latency, or jitter in user interactivity with the wireless device.

Accordingly, the present disclosure provides systems and methods for concurrent Wi-Fi Aware discovery and WLAN operation. As described herein, the present disclosure includes a computer implemented method that efficiently maintains concurrent operation in multiple bands, where the operation in one of the bands is active only intermittently. The methods also include incorporating at least two antennas that concurrently operate in the multiple bands. During a Wi-Fi Aware discovery operation, a first of the two antennas operates in a different band than a second of the two antennas, allowing the first antenna to conduct a discovery window in a lower frequency band for NAN while the second antenna maintains operation in a higher frequency band, e.g., to maintain connection with an access point. The present disclosure allows a non-AP STA to perform Wi-Fi Aware discovery operations without suffering performance losses, e.g., caused by temporary connection reduction or loss to the AP.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of the present disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

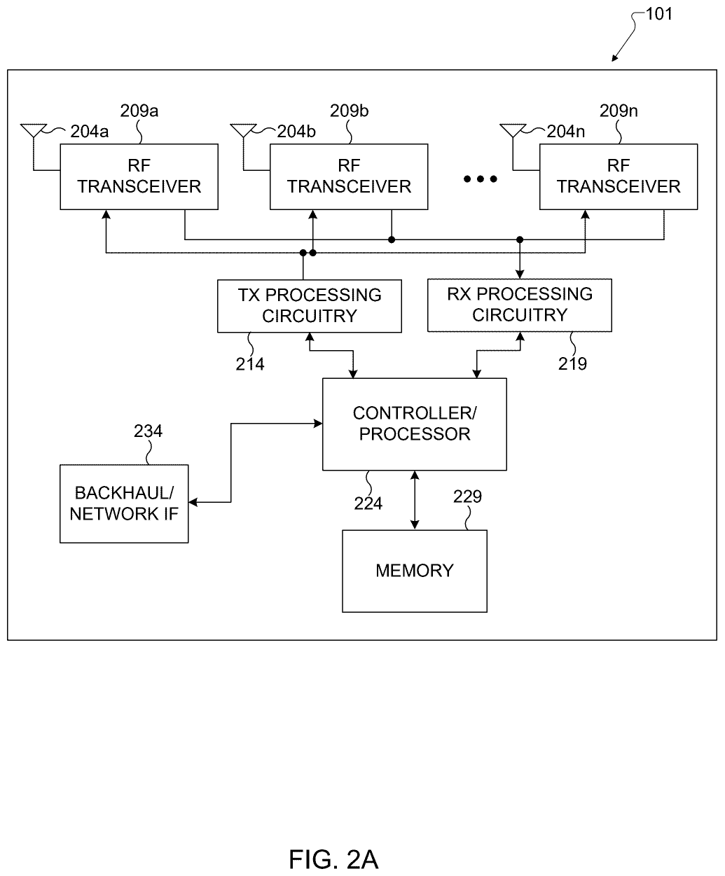

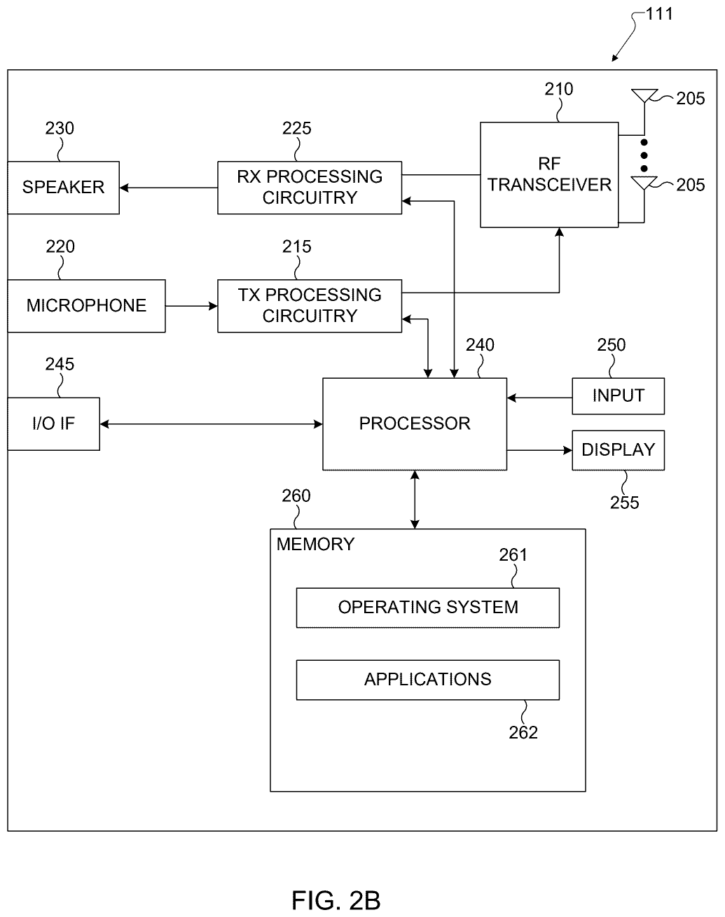

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of the present disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of the present disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 can move data into or out of the memory 260 as required by an executing process. In some embodiments, the controller/processor 240 is configured to execute a plurality of applications 262. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

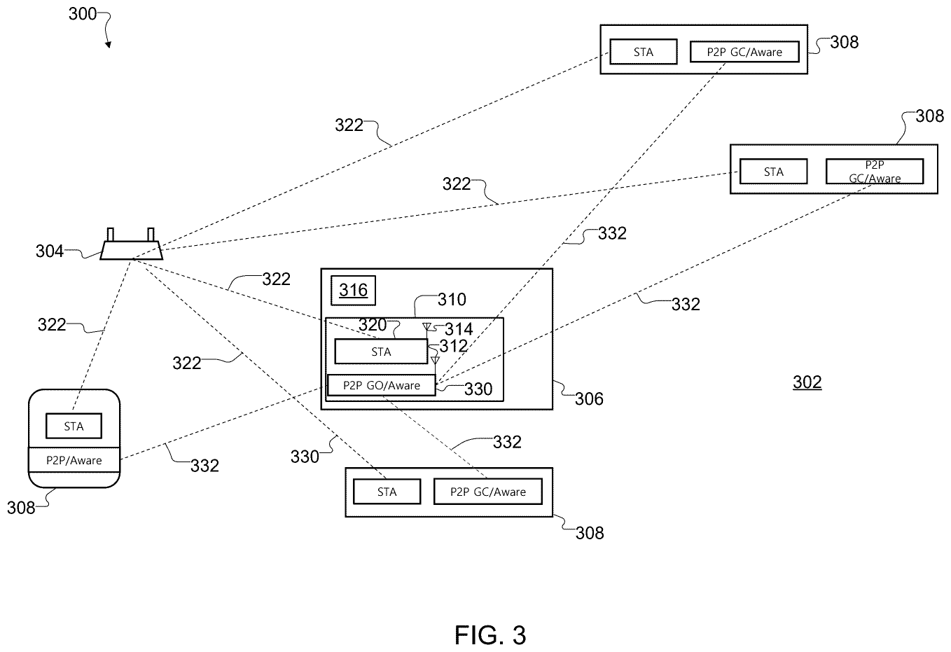

FIG. 3 illustrates an example system performing concurrent Wi-Fi Aware discovery and WLAN operation in an environment according to various embodiments of the present disclosure. For ease of explanation, the system 300 will be described as including one or more components of the wireless network 100 of FIG. 1, such as the STAs 111-114; however, the system 300 could be implemented using any other suitable device or system. The embodiment of the system 300 shown in FIG. 3 is for illustration only. Other embodiments of the system 300 could be used without departing from the scope of the present disclosure.

As shown in FIG. 3, the system 300 includes a service area 302, an access point (AP) 304, a first wireless device 306, and a plurality of user devices 308. The first wireless device 306 includes a radio frequency (RF) module 310 that has a first antenna 312 disposed in the RF module 310, a second antenna 314 disposed in the RF module 310, and a processor 316 operably coupled to the first antenna 312 and the second antenna 314.

The service area 302 is a geographical area in which a location-based service identifies target objects. In the system 300, the service area 302 represents an indoor space in which the first wireless device 306 may be located. In some embodiments, the first wireless device 306 is a personal consumer device, such as a smart television or smart phone. The first wireless device 306 may represent (or be represented by) one of the STAs 111-114.

The first wireless device 306 may also include a STA module 320, coupled to the second antenna 314, that is configured to maintain an AP connection 322 with the AP 304, where the AP 304 is a second wireless device. Similarly, the first wireless device 306 may also include a NAN module 330, coupled to the first antenna 312, that is configured to maintain a peer-to-peer (P2P) connection 332 with the plurality of user devices 308. Optionally, the plurality of user devices 308 may also each maintain an AP connection 322 with the AP 304, e.g., as one of the STAs 111-114. The plurality of user devices 308 may include electronic devices, such as mobile phones and audio systems, that are configured to establish a peer-to-peer connection with the first wireless device 306.

The first wireless device 306 may be an example device, a TV, connected to the AP 304 on a channel, e.g., in a 5 GHz band, to perform an infrastructure WLAN operation while also participating in NAN synchronization and discovery on channel 6, e.g., in a 2.4 GHz band for device-to-device operation. Therefore, the first wireless device 306 needs to maintain concurrent infrastructure WLAN operation and NAN operation in different bands.

Although FIG. 3 illustrates one example of a system, various changes may be made to FIG. 3. For example, a different electronic devices may be present or the RF module may include additional antenna elements to perform one or more of the above functions.

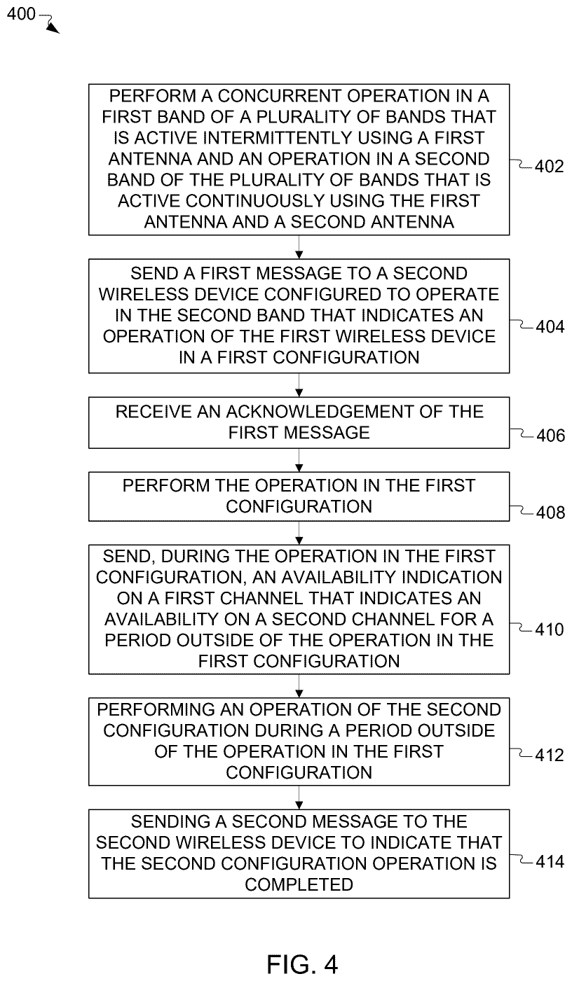

To operate with concurrent Wi-Fi Aware discovery and WLAN capabilities, the system may use a plurality of antenna configurations. An example method of concurrent Wi-Fi Aware discovery and WLAN operation using a plurality of antenna configurations is further described regarding FIG. 4.

FIG. 4 illustrates an example method of concurrent Wi-Fi Aware discovery and WLAN operation according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of concurrent Wi-Fi Aware discovery and WLAN operation could be used without departing from the scope of the present disclosure.

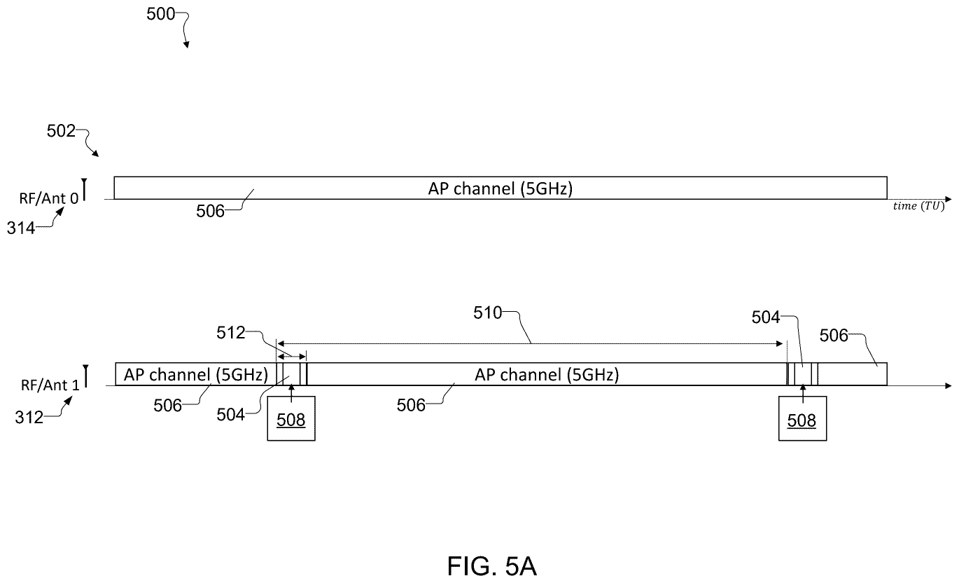

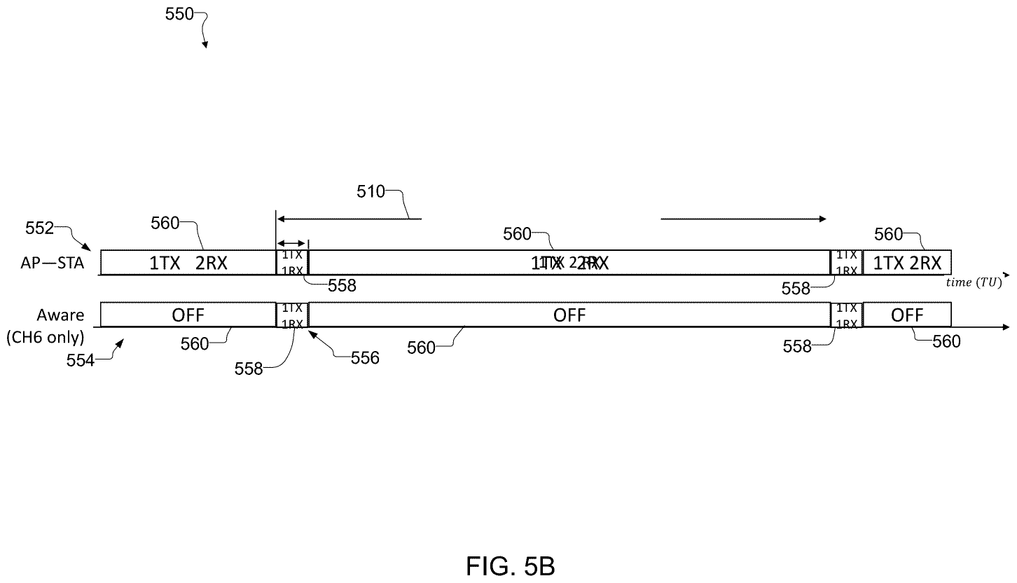

FIG. 5A illustrates an example band operation timeline 500 of a system 300 undergoing a method 400 of concurrent Wi-Fi Aware discovery and WLAN operation according to embodiments of the present disclosure. FIG. 5B illustrates an example channel configuration timeline 550 of a system 300 undergoing a method 400 of concurrent Wi-Fi Aware discovery and WLAN operation according to embodiments of the present disclosure. The embodiment of the band operation timeline 500 illustrated in FIG. 5A and the channel configuration timeline 550 shown in FIG. 5B are for illustration only. Other embodiments of a band operation timeline 500 or channel configuration timeline 550 could be used without departing from the scope of the present disclosure.

As illustrated in FIG. 4, the method 400 begins at step 402. At step 402, the method 400 includes performing a concurrent operation in a first band 504 of a plurality of bands 502 that is active intermittently using a first antenna 312 and an operation in a second band 506 of the plurality of bands 502 that is active continuously using the first antenna 312 and a second antenna 314. In particular, a system 300 may perform a concurrent operation at a first wireless device, e.g., the first wireless device 306, in a plurality of bands 502. Operation in a first band 504 of the plurality of bands 502 is active intermittently using the first antenna 312 and based on configurations of a radio frequency (RF) module 310 of the first wireless device. Operation in a second band 506 of the plurality of bands 502 is active continuously using the first antenna 312 and a second antenna 314.

The configurations of the RF module 310 include a first configuration 558 and a second configuration 560. The first configuration 558 may be used to initiate an intermittently active discovery operation 556 in the first band 504 during which peer-to-peer communication and NAN operations, e.g., device mirroring, are performed. The second configuration 560 may be used to end the intermittently active discovery operation 556 in the first band 504.

The first configuration 558 comprises using the first antenna 312 to operate in the first band 504 and concurrently using the second antenna 314 to operate in the second band 506. The second configuration 560 comprises using the first antenna 312 and the second antenna 314 to operate in the second band 506.

The concurrent Wi-Fi Aware discovery and WLAN operations using a plurality of antenna configurations may also use different channel configurations over time. The first wireless device 306 may perform a first configuration operation to set the first antenna 312 and the second antenna 314 in the first configuration 558, e.g., setting the first antenna 312 to operate in the first band 504. An example channel configuration timeline from concurrent Wi-Fi Aware discovery and WLAN operation is further described regarding FIG. 5B. As mentioned above, NAN operation requires the RF communication to be active on the first antenna 312 only intermittently, e.g., during a subset of discovery windows 508, and possibly for discovery beacon transmissions if the first wireless device 306 acts as Master of a NAN cluster.

To achieve concurrent operation, the first wireless device 306 may maintain at least one receiver antenna and a transmitter antenna on an AP channel 552 in a second band 506 and dynamically switch one or more receiver antennas from the AP channel 552 in the second band 506 to the NAN channel 554 in the first band 504 during the discovery window 508. In addition, the first wireless device 306 may include at least one transmitter antenna on the NAN channel 554.

The discovery windows 508 occur during a discovery window interval 510. The discovery window interval 510 is a period that includes the discovery window 508 where the first antenna 312 and the second antenna 314 are operating in the first configuration 558, e.g., the first antenna 312 is operating in the first band 504 for NAN functions, and an “active period” where the first antenna 312 and the second antenna 314 are in the second configuration 560, e.g., both the first antenna 312 and the second antenna 314 are operating in the second band 506 and communicating with the AP 304. In other words, the discovery window interval 510 is a period between the beginning of one discovery window 508 and another discovery window 508. The discovery window 508 also includes a discovery window length 512 and may last a small fraction of the time of the discovery interval. For example, if the discovery window interval 510 has a duration of 8000 ms, the discovery window length 512 may only last 16 ms. A short discovery window length 512 minimizes the amount of time that the first wireless device 306 is in the first configuration 558, allowing longer time in the second configuration 560 that allows for maximum data transmission.

At step 404, the method 400 includes sending a first message 604 to a second wireless device configured to operate in the second band 506 that indicates an operation of the first wireless device in a first configuration 558. In particular, sending, before the start of the intermittently active discovery operation 556, a first message 604 to a second wireless device configured to operate in the second band 506, wherein the first message 604 indicates an operation of the first wireless device in the first configuration 558. The first message 604 may be a spatial multiplexing power save (SMPS) signal, an operating mode notification action frame (OMN AF) signal, or an operating mode indication A-control signal.

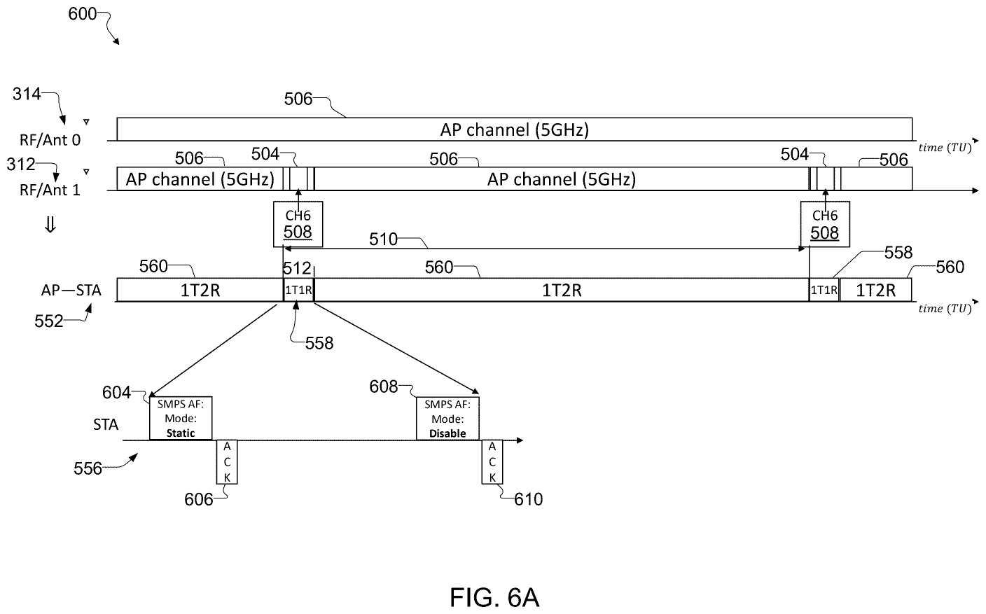

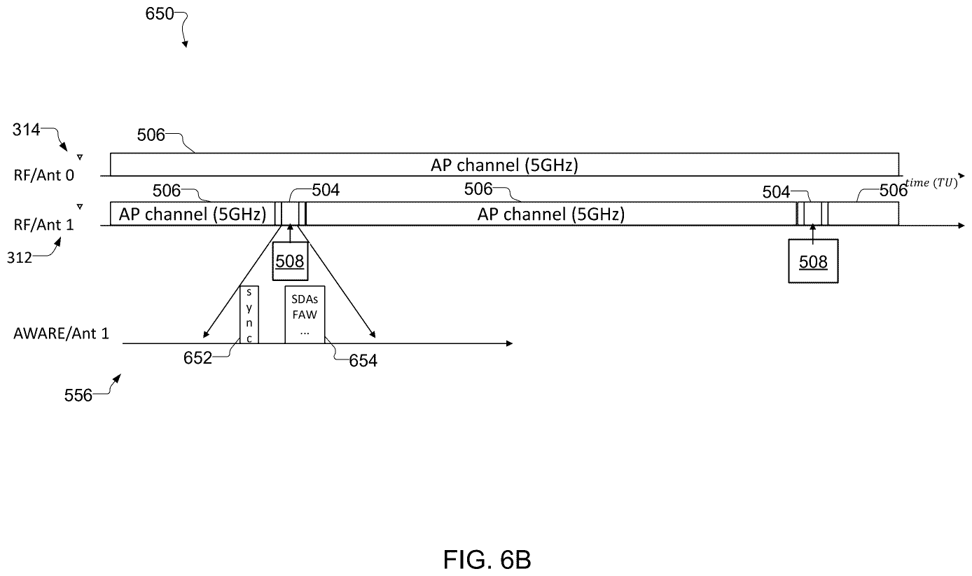

The concurrent Wi-Fi Aware discovery and WLAN operations using a plurality of antenna configurations may also notify access points of a change in antenna configuration of the electronic device. An example notification timeline from concurrent Wi-Fi Aware discovery and WLAN operation is further described regarding FIG. 6A.

FIG. 6A illustrates an example notification timeline 600 of a system 300 undergoing a method 400 of concurrent Wi-Fi Aware discovery and WLAN operation according to embodiments of the present disclosure. The embodiment of the system 300 shown in FIG. 3 is for illustration only. Other embodiments of the system 300 could be used without departing from the scope of the present disclosure.

Before initiating the intermittently active discovery operation 556, the first wireless device may send a first message 604 indicating the RF reconfiguration of the first antenna 312 and the second antenna 314 into the first configuration 558. The first message 604 may be sent using a Spatial Multiplexing Power Save (SMPS) Spatial Multiplexing Power Save Action Frame to indicate a change in number of supported spatial streams or number of receiver antennas. Using SMPS allows a STA, e.g., the first wireless device 306, to indicate to the AP 304, e.g., the second wireless device, that the AP 304 must assume the first wireless device 306 is operating with a single receiver antenna, e.g., the second antenna 314. While SMPS affords the first wireless device 306 power saving by turning off some receiver chains, it can also be used when the first wireless device 306 is devoting those receiver chains, e.g., the first antenna 312, towards concurrent operation instead of turning them off for power saving. In the SMPS Action Frame send prior to the start of the discovery window 508, the first message 604 may indicate enabling SMPS in Static mode. As a result, the AP 304 will assume the first wireless device 306 can support only one spatial stream or has only one antenna active, e.g., the second antenna 314, and schedule download transmissions accordingly.

At step 406, the method 400 includes receiving an acknowledgement 606 of the first message 604. In particular, receiving, from the second wireless device, an acknowledgement of the first message 604.

The first wireless device 306 may send an RF reconfiguration indication to the AP 304 just before switching receiver antennas away from the AP channel 552 to the NAN channel 554, the RF reconfiguration indication indicating a reduction of the RF capability of the first wireless device 306 such as number of receiver antenna or a number of supported receiver spatial streams. Likewise, the first wireless device 306 may send an RF reconfiguration indication to the AP 304 as soon as the NAN channel 554 active window ends and the receiver chains have been switched back to the AP channel 552 from the NAN channel 554, this time indicating an increase in RF capability such as number of receiver antenna or a number of supported receiver spatial streams. The benefit of informing the AP 304 about the changes in RF configuration is that the AP 304 can then adapt its download transmission using link adaptation. For example, the AP 304 can select an appropriate modulation coding scheme (MCS) for download transmission to the first wireless device 306, considering the reduction of receiver antennas. For example, if the first wireless device 306 has indicated reducing receiver antennas to one, the AP 304 may avoid selecting MCSs with two or more spatial streams. Furthermore, the AP 304 may select an MCS with lower decoding SNR threshold, e.g., about 3 dB lower if the first wireless device 306 indicates reducing receiver antenna down to one from two. By contrast, if the first wireless device 306 had not sent an RF reconfiguration indication to the AP 304, the selected MCS may be too high for the first wireless device 306 to decode, resulting in errors and retransmissions until the link adaptation at the AP 304 converges to a correct MCS to match the new RF configuration. Therefore, without the indication, link adaptation in download at the AP 304 will take longer to converge. There is a similar benefit in sending an RF reconfiguration indication at the end of the NAN channel 554 active window, to indicate increase in RF capability.

The benefit of the first wireless device 306 sending the RF reconfiguration indication, e.g., the first message 604, may be even more pronounced where the duration of the discovery window 508, e.g., the duration over which the first wireless device 306 reduces its RF capability in the AP channel 552 to divert one or more RF chains to NAN operation, is short.

At step 408, the method 400 includes performing the operation in the first configuration 558. In particular, performing the first configuration 558 operation at the first wireless device 306.

At step 410, send, the method 400 includes during the operation in the first configuration 558, an availability indication on a first channel that indicates an availability on a second channel for a period outside of the operation in the first configuration 558. In particular, sending, during the intermittently active discovery operation 556, an availability indication on a first channel, wherein the availability indication indicates an availability of the first wireless device on a second channel of the concurrent operation for a period outside of the intermittently active discovery operation.

At step 412, the method 400 includes performing an operation of the second configuration 560 during a period outside of the operation in the first configuration 558. In particular, performing an operation of the second configuration 560 at the first wireless device during a period outside of the intermittently active discovery operation.

At step 414, the method 400 includes sending a second message 608 to the second wireless device to indicate that the second configuration 560 operation is completed. In particular, sending a second message 608 using the first wireless device to a second wireless device to indicate that the second configuration 560 operation is completed. The second message 608 may be a spatial multiplexing power save (SMPS) signal, an operating mode notification action frame (OMN AF) signal, or an operating mode indication A-control signal. The first wireless device 306 may then receive, from the AP 304, an acknowledgement 610 of the second message 608.

At the end of the intermittently active discovery operation 556 or when the first wireless device 306 has switched the first antenna 312 backs to AP 304 channel away from the NAN channel 554, the first wireless device 306 may once again send an SMPS Action Frame indicating that SMPS has been disabled or set to dynamic, as suitable.

The first wireless device 306 is connected to an AP 304 on the AP channel 552 in the first band 504, e.g., for Infrastructure WLAN operation, and determines, using the processor 316, the start of the discovery window 508 of concurrent operation on the NAN channel 554 in the second band 506, e.g., for NAN operation. Just before to the start of the discovery window 508, sends a first message 604 to the AP 304 and reconfigures one or more antennas, e.g., the first antenna 312, to operate on the NAN channel 554 while keeping at least one RF chain operating on the AP channel 552, determines the end of the discovery window 508 of concurrent operation, and at the end of the concurrent operation reconfigures the previously reconfigured antennas, e.g., the first antenna 312, to now once again operate on the AP channel 552, and sends a second message 608 to the AP 304. The first message 604 indicates the reduction in the RF communication capabilities of the first wireless device 306 whereas the second message 608 indicates an increase the RF communication capabilities of the first wireless device 306.

An advantage of the disclosed method 400 is that, unlike the methods that include the wireless device temporarily ceasing communication with an access point, the data communication on Infrastructure WLAN, e.g., the AP connection 322, is not suspended for the duration of the discovery window 508. Instead, the download, e.g., data transfer from the AP 304 to the first wireless device 306, data capacity is merely reduced due to the reduction of one or more receiver antennas, e.g., the first antenna 312.

Although FIG. 4 illustrates one example concurrent Wi-Fi Aware discovery and WLAN operation method 400, various changes may be made to FIG. 4. For example, while shown as a series of steps, various steps in FIG. 4 could overlap, occur in parallel, occur in a different order, or occur any number of times.

Similarly, although FIGS. 5A and 5B illustrate one example of band operation timeline and a channel configuration timeline, various changes may be made to FIGS. 5A and 5B. For example, different frequencies for each band may be utilized.

In addition to normal discovery operation, the concurrent Wi-Fi Aware discovery and WLAN operations using a plurality of antenna configurations may also indicate discovery availability of the electronic device to other devices in the system. An example discovery operation timeline from concurrent Wi-Fi Aware discovery and WLAN operation is further described regarding FIG. 6B.

FIG. 6B illustrates an example discovery operation timeline 650 of a system 300 undergoing a method 400 of concurrent Wi-Fi Aware discovery and WLAN operation according to embodiments of the present disclosure. The embodiment of the system 300 shown in FIG. 3 is for illustration only. Other embodiments of the system 300 could be used without departing from the scope of the present disclosure.

During concurrent operation of the first wireless device 306 between Infrastructure WLAN on the AP channel 552 in the first band 504, e.g., a 5 GHz band, and the intermittently active discovery operation 556 on the NAN channel 554 in the second band 506, e.g., a 2.4 GHz band, the first wireless device 306 diverted some RF chains away from AP channel 552 to NAN channel 554 only when necessary, and indicated the change in its RF configuration to the AP 304 each time. The present disclosure can exploit the flexibility provided by NAN standard to minimize the time necessary on the NAN channel 554. For example, the discovery window interval 510 may be configured to sub-select the discovery windows 508 that the first wireless device 306 will monitor. Further, the first wireless device 306 may indicate its availability, e.g., in a NAA (NAN Availability Attribute), on the AP channel 552, e.g., the same channel on which the first wireless device 306 is conducting Infra WLAN operation or any other concurrent operation, by transmitting SDAs and attribute containing further availability windows (FAWs) 654, after transmitting a synchronization frame 652.

Once devices, such as the plurality of user devices 308, discover the first wireless device 306 during a discovery window 508, the plurality of user devices 308 will also obtain a FAW 654 for the first wireless device 306, indicating the time the first wireless device 306 is available on the AP channel 552 during Infrastructure WLAN operation. The plurality of user devices 308 may then perform Subscribe, Follow-up, Further Discovery, or NDP (NAN Data Path) setup all on the AP channel 552 rather than being limited to completing setup during the discovery window 508 on the NAN channel 554. Therefore, the first wireless device 306 can exploit the flexibility of NAN and move a subset of NAN operation to the same channel as its Infra WLAN operation and participate in both operations simultaneously. That is, the first wireless device 306 need not operate on the NAN channel 554 at any other time outside of the (sub-selected) discovery windows to perform NAN operations with other devices.

The present disclosure provides for systems and methods for concurrent Wi-Fi Aware discovery and WLAN operations using a system including an electronic device functioning as a station that is connected to an access point. The electronic device includes at least two antennas; a first antenna to intermittently operate in a first band, e.g., a frequency band used for Wi-Fi Aware discovery, and a second antenna to continuously operate in a second band, e.g., a frequency band used to maintain a connection with the access point. The first antenna, when not operating in the first band, operates in the second band along with the second antenna. The intermittent switching of the first antenna between the first band and the second band allows for improved performance of the electronic device, e.g., reduced data loss, due to a consistent connection with the access point, while allowing the electronic device to perform Wi-Fi Aware discovery operations with other devices.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular clement. step, or function is an essential clement that must be included in the claims scope. The scope of patented subject matter is defined by the claims.

What is claimed is:

1. A method of operating a first wireless device, the method comprising:
performing a concurrent operation at a first wireless device in a plurality of bands, wherein operation in a first band of the plurality of bands is active intermittently using a first antenna and based on configurations of a radio frequency (RF) module of the first wireless device and operation in a second band of the plurality of bands is active continuously using the first antenna and a second antenna, the configurations of the RF module including:
a first configuration to initiate an intermittently active discovery operation in the first band; and
a second configuration to end of the intermittently active discovery operation in the first band.

2. The method of claim 1, further comprising:
sending, before initiating the intermittently active discovery operation, a first message to a second wireless device configured to operate in the second band, wherein the first message indicates an operation of the first wireless device in the first configuration;
receiving, from the second wireless device, an acknowledgement of the first message; and
performing a first configuration operation to set the first antenna and the second antenna into the first configuration to initiate the intermittently active discovery operation at the first wireless device.

3. The method of claim 2, wherein the first configuration comprises using the first antenna to operate in the first band and concurrently using the second antenna to operate in the second band.

4. The method of claim 1, wherein the second configuration comprises using the first antenna and the second antenna to operate in the second band.

5. The method of claim 2, wherein the first message is a spatial multiplexing power save (SMPS) signal, an operating mode notification action frame (OMN AF) signal, or an operating mode indication A-control signal.

6. The method of claim 1, further comprising:
performing an operation of the second configuration at the first wireless device during a period outside of the intermittently active discovery operation; and
sending a second message using the first wireless device to a second wireless device to indicate that the operation of the second configuration is completed.

7. The method of claim 6, wherein the second message is a spatial multiplexing power save (SMPS) signal, an operating mode notification action frame (OMN AF) signal, or an operating mode indication A-control signal.

8. The method of claim 1, further comprising:
sending, during the intermittently active discovery operation, an availability indication on a first channel, wherein the availability indication indicates an availability of the first wireless device on a second channel of the concurrent operation for a period outside of the intermittently active discovery operation.

9. The method of claim 8, wherein performing the concurrent operation at the first wireless device in the plurality of bands comprises using the first antenna to continuously operate in the second channel and the second antenna to perform the intermittently active discovery operation.

10. An electronic device, comprising:
a radio frequency (RF) module;
a first antenna disposed in the RF module;
a second antenna disposed in the RF module; and
a processor operably coupled to the first antenna and the second antenna, configured to cause the electronic device to:
perform a concurrent operation in a plurality of bands, wherein operation in a first band of the plurality of bands is active intermittently using the first antenna and based on configurations of the RF module and operation in a second band of the plurality of bands is active continuously using the first antenna and the second antenna, the configurations of the RF module including:
a first configuration to initiate an intermittently active discovery operation in the first band; and
a second configuration to end of the intermittently active discovery operation in the first band.

11. The electronic device of claim 10, wherein the second configuration comprises using the first antenna and the second antenna to operate in the second band.

12. The electronic device of claim 10, wherein the processor is further configured to cause the electronic device to:
send, before initiating the intermittently active discovery operation, a first message to a second wireless device configured to operate in the second band, wherein the first message indicates an operation of the electronic device in the first configuration;
receive, from the second wireless device, an acknowledgement of the first message; and
perform a first configuration operation to set the first antenna and the second antenna into the first configuration to initiate the intermittently active discovery operation at the electronic device.

13. The electronic device of claim 10, wherein the processor is further configured to cause the electronic device to:
perform an operation of the second configuration at the electronic device during a period outside of the intermittently active discovery operation; and
send a second message using the electronic device to a second wireless device to indicate that the operation of the second configuration is completed.

14. The electronic device of claim 10, wherein the processor is further configured to cause the electronic device to:
send, during the intermittently active discovery operation, an availability indication on a first channel, wherein the availability indication indicates an availability of electronic device on a second channel of the concurrent operation for a period outside of the intermittently active discovery operation.

15. The electronic device of claim 14, wherein the processor, when causing the electronic device to perform the concurrent operation at the electronic device in the plurality of bands, is further configured to cause the electronic device to use the first antenna to continuously operate in the second channel and the second antenna to perform the intermittently active discovery operation.

16. A non-transitory computer-readable medium comprising program code, that when executed by at least one processor of an electronic device, causes the electronic device to:
perform a concurrent operation in a plurality of bands, wherein operation in a first band of the plurality of bands is active intermittently using a first antenna and based on configurations of a radio frequency (RF) module of the electronic device and operation in a second band of the plurality of bands is active continuously using the first antenna and a second antenna, the configurations of the RF module including:
a first configuration to initiate an intermittently active discovery operation in the first band; and
a second configuration to end of the intermittently active discovery operation in the first band.

17. The non-transitory computer-readable medium of claim 16, the second configuration comprises using the first antenna and the second antenna to operate in the second band.

18. The non-transitory computer-readable medium of claim 16, further comprising program code, that when executed by at least one processor of an electronic device, causes the electronic device to:
send, before initiating the intermittently active discovery operation, a first message to a second wireless device configured to operate in the second band, wherein the first message indicates an operation of the electronic device in the first configuration;
receive, from the second wireless device, an acknowledgement of the first message; and
perform a first configuration operation to set the first antenna and the second antenna into the first configuration to initiate the intermittently active discovery operation at the electronic device.

19. The non-transitory computer-readable medium of claim 16, further comprising program code, that when executed by at least one processor of an electronic device, causes the electronic device to:
send, during the intermittently active discovery operation, an availability indication on a first channel, wherein the availability indication indicates an availability of electronic device on a second channel of the concurrent operation for a period outside of the intermittently active discovery operation.

20. The non-transitory computer-readable medium of claim 19, wherein the program code, that when executed by the at least one processor, causes the electronic device to perform the concurrent operation at the electronic device in the plurality of bands, comprises program code, that when executed by the at least one processor, causes the electronic device to use the first antenna to continuously operate in the second channel and the second antenna to perform the intermittently active discovery operation.
